(19) United States
(12) Patent Application Publication
(10) Pub. No.: US 2018/0180755 A1
(43) Pub. Date: Jun. 28, 2018

(54) METHOD FOR ANGLE-DOMAIN COMMON IMAGE GATHER

(71) Applicants: China Petroleum & Chemical Corporation, Beijing (CN); Sinopec Tech Houston, LLC., Houston, TX (US)

(72) Inventor: Rui YAN, Houston, TX (US)

(21) Appl. No.: 15/857,343

(22) Filed: Dec. 28, 2017

Related U.S. Application Data
(60) Provisional application No. 62/439,630, filed on Dec. 28, 2016.

(51) Int. Cl. G01V 1/36; G01V 1/28

(52) U.S. Cl. CPC G01V 1/362; G01V 1/282; G01V 2210/40; G01V 2210/679; G01V 2210/632

(57) ABSTRACT

A method for angle-domain common image gather (ADCIG) of a subsurface formation includes the step of converting seismic incident waves and seismic scattered waves at each of a number of image locations from time domain to frequency domain using Fourier transform. At each image location, the seismic waves in the frequency domain are decomposed into a number of local plane waves. Applying a cross-correlating imaging condition amongst the local plane waves to obtain a partial image at each image location. The plurality of partial images are then sorted into the angle domain.

### CROSS-REFERENCE TO RELATED APPLICATION

This application claims priority to U.S. Provisional Patent Application having Ser. No. 62/439,630, filed Dec. 28, 2016, and is incorporated herein by reference in its entirety.

### FIELD OF TECHNOLOGY

The present disclosure relates generally to an improved method for angle-domain common image gather (ADCIG). More specifically, the present disclosure relates to fast implementation of plane wave decomposition for ADCIG.

### BACKGROUND

Reverse-time migration (RTM) is becoming a widely used image migration method in the oil and gas industry because of its robustness in imaging subsurface structures in complex geological models. The RTM reconstructs forward propagated source wavefield and back propagated receiver wavefield by full-wave propagator. It then applies an imaging condition to extract reflectivity information from the reconstructed wavefields. The RTM is highly flexible in handling complex velocity models and reproduces realistic wave phenomena (e.g., reflections, refractions, diffractions, and evanescent waves). The full-wave equation based RTM can propagate waves in all directions without any angle limitation and image steep structures with dip angles up to 180°, giving it advantages over other migration methods.

There are two general steps in the implementation of RTM. First, one must model two wavefields—the source wavefield and the receiver wavefield. That is, to reconstruct the incident wave and a scattered/reflected wave involved in a reflection. Then, an imaging condition that is a zero-lag time-correlation at each subsurface point is applied to the model.

The imaging condition states that the reflector is located where the source and receiver waves are coincident at the same place and time. However, cross-correlation imaging condition stacks waves coming from all directions, which effectively suppresses the noise but also masks the directional information in the data.

In comparison, expanding the image in reflection angle domain, i.e., generating angle-domain common image gather (ADCIG), adds an extra dimension to the conventional image. For example, the moveout of the ADCIG carries the phase or travel time errors for waves propagating with different angles through the velocity model. They can be used for migration velocity analysis (MVA).

Dynamic information such as amplitude versus angle (AVA) is crucial in reservoir interpretation. However, complex overburden structures often obscure the signals from the reservoir. Extracting AVA from the ADCIG provides an effective way to remove the propagation effect. Imaging in the local angle domain is an essential element in obtaining high-fidelity subsurface images and reliable petro-physical parameters.

### SUMMARY

The present disclosure provides a method for angle-domain common image gather (ADCIG) of a subsurface formation. The method includes the step of converting seismic waves at one of a plurality of image locations from the time domain to the frequency domain using Fourier transform. The seismic waves include both incident waves (i.e., source-side waves) and the scatter waves (i.e., receiver-side waves).

The seismic waves in the frequency domain are decomposed into a plurality of local plane waves at the one of the plurality of image locations. The local plane waves include both local incident plane waves decomposed from incident waves and local scattered plane waves decomposed from scattered waves. A partial image is obtained at each image location by cross-correlating combinations of local incident plane wave and local scattered plane wave. The plurality of partial images are then sorted into the reflection angle domain.

The step of decomposing include comprises stacking the plurality of local plane waves along z-direction according to equation (10) to obtain a first summation, followed by stacking the first summation long x-direction according to equation (11) to obtain a second summation, and then stacking the second summation along y-direction according to equation (12) to obtain a third summation.

### BRIEF DESCRIPTION OF THE DRAWINGS

FIG. 1 illustrates a slowness analysis of a salt-dome model.

FIG. 2 illustrates a coordinate system used in an angle-domain analysis in the present disclosure.

FIG. 3 compares wavefields reconstructed according to the method of the current disclosure (dotted lines) with the original wavefields (solid lines) and wavefields reconstructed using a conventional method (dash lines).

FIG. 4 shows the wave velocities in a Marmousi2 model.

FIG. 5 shows ADCIG images of the Marmousi2 computed using a method of the current disclosure.

### DETAILED DESCRIPTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the scope of the present disclosure.

The Figures and the following description relate to the embodiments of the present disclosure by way of illustration only. It should be noted that from the following discussion, alternative embodiments of the structures and methods disclosed herein will be readily recognized as viable alternatives that may be employed without departing from the principles of the claimed inventions.

Referring to the drawings, embodiments of the present disclosure will be described. Various embodiments can be implemented in numerous ways, including for example as a system (including a computer processing system), a method (including a computer implemented method), an apparatus, a non-transitory computer readable medium, a computer program product, a graphical user interface, a web portal, or a data structure tangibly fixed in a non-transitory computer readable memory. Several embodiments of the present invention are discussed below. The appended drawings illustrate only typical embodiments of the present disclosure and therefore are not to be considered limiting of its scope and breadth.

Reference will now be made in detail to several embodiments of the present disclosure(s), examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures and methods illustrated herein may be employed without departing from the principles of the disclosure described herein.

To build ADCIG, both source and receiver wavefields are decomposed into superposition of local plane waves (or beams) propagating in different directions. Fourier transform is employed to convert the wavefields from time domain to frequency domain. In the frequency domain, plane wave decomposition is conducted according to equation (1):

u(p,r,ω)=∫W(r′−r)u(r′,ω)e^{-iω(r′-r)p}dr′, (1)

where u(p,r,ω) is the decomposed local plane wave, W(r′−r) is a window function centered at r while ω is the frequency, and p is the slowness vector defined as

$$p = \frac{\hat{e}}{\overline{v}} ,$$

in which ê is the unit slowness vector specifying the propagation direction of the local plane wave; ν̅ is the average velocity in the sampling window W.

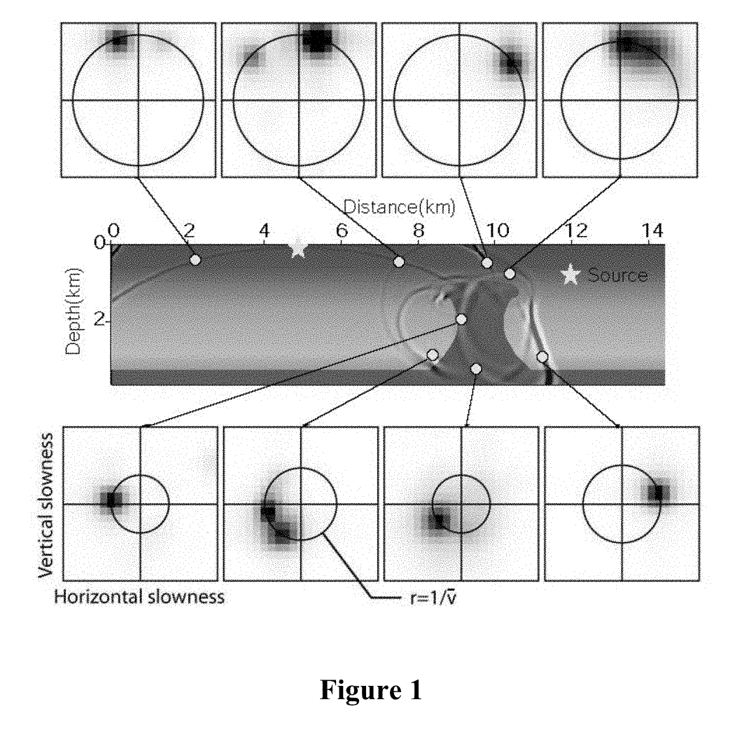

FIG. 1 explains the formulation of plane wave decomposition via a slowness analysis in a salt dome model (middle panel). The model is composed of a background velocity varying in depth and a salt dome with steep flanks. Overlapped on the model is a snapshot of the wavefield generated from the labeled source location. The slowness analyses scan over a wide range of slowness vectors using equation 1. The top panel and the bottom panel in FIG. 1 are results of slowness analyses at selected locations indicated in the wavefield. The slowness vectors, i.e., the vectors from the origin of the polar coordinate to these energy peaks, reveal the wave propagation directions. At the location simultaneously swept by multiple wave fronts, multiple energy peaks are shown in slowness domain, but without exception all the energy peaks fall on a circle with a radius of 1/ν̅. That's where the dispersion relation is satisfied. With the increase in depth, the radii of these circles become smaller due to the increase of velocities. Therefore, it is not necessary to compute every slowness component in order to decompose the wavefield into local plane waves. Rather, the decomposition is carried out along the dispersion circle.

In 3D cases, the dispersion circle becomes a dispersion sphere. All possible slowness vectors ending at the dispersion sphere are scanned, so the corresponding local plane component can be expressed according to equation (2)

u(θ,φ,r,ω)=∫W(r′−r)u(r′,ω)e^{-iω(r′-r)·ê/ν̅}dr, (2)

where θ is the polar angle and φ is the azimuth angle of unit slowness vector ê in 3D case.

The original wavefield can be reconstructed by the summation of the plane wave component according to equation (3):

$$u ( r , ω ) = \int \frac{{ω}^{2}}{{\overline{v}}^{2}} sin θ u ( θ , ϕ , r , ω ) d θ d ϕ , \qquad ( 3 )$$

where

$$\frac{{ω}^{2}}{{\overline{v}}^{2}} sin θ$$

is the Jacobian coefficient in 3D case.

The image is produced by the cross-correlation imaging condition between source (i.e., incident) waves and receiver (scattered/reflected) waves. In frequency domain, it can be expressed as equation (4):

I(r)=∫uₛ(r,ω)u_{g}(r,ω)dω, (4)

where I(r) is the depth image. The subscripts stands for source-side and subscript g stands for receiver-side. The image is then expanded into angle domain by substituting equation (4) with equation (3), which produces equation (5):

I(r)=∫I(pₛ,p_{g},r)dpₛdp_{g}, (5)

where

I(pₛ,p_{g},r)=pₛ²p_{g}² sin θₛ sin θ_{g}∫ω⁴uₛ(pₛr,ω)u_{g}(p_{g},r,ω)dω, (6)

is the angle-domain partial image. The reflection angles corresponding to the partial image can be calculated by

$$\begin{matrix}cos {θ}_{r} = \frac{( {p}_{s} + {p}_{g} ) \cdot {p}_{s}}{\vert {p}_{s} + {p}_{g} \vert \vert {p}_{s} \vert} , & ( 7 ) \\ cos {ϕ}_{r} = \frac{( {p}_{s} \times {p}_{g} ) \cdot ( {n}_{x} \times ( {p}_{s} + {p}_{g} ) )}{\vert {p}_{s} \times {p}_{g} \vert \vert {n}_{x} \times ( {p}_{s} + {p}_{g} ) \vert} . & ( 8 )\end{matrix}$$

where nₓ=(1,0,0).

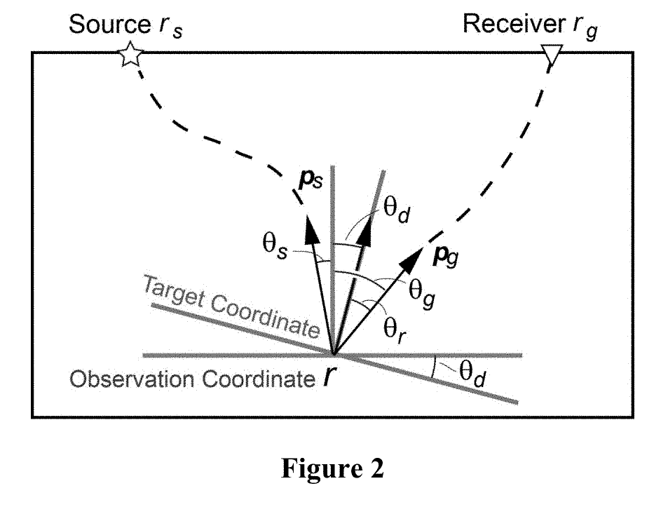

FIG. 2 illustrates the coordinate system used in this calculation. Accordingly, the angle-domain partial image can be mapped into reflection angle, resulting in an angle-domain common image gather (ADCIG).

The plane wave decomposition described above requires great computational cost when applied to a large dataset. According to one embodiment of the present disclosure, a method that implements the plane wave decomposition is computationally less expensive. This method is explained below in comparison with conventional methods.

For an image location r=(xᵢ, yⱼ, zₖ), its conventional plane wave decomposition given by equation (1) can be expressed in a discrete form

$$u ( {e}_{x} , {e}_{y} , {e}_{z} , {x}_{i} , {y}_{j} , {z}_{k} , ω ) = \frac{1}{M \times N \times L} {\sum }_{n = - N \text{/} 2}^{N \text{/} 2} {\sum }_{m = - M \text{/} 2}^{M \text{/} 2} {\sum }_{L = - L \text{/} 2}^{L \text{/} 2} u ( {x}_{i + m} , {y}_{j + n} , {z}_{k + l} , ω ) {e}^{- i ω ( m \cdot {e}_{x} Δ x + n \cdot {e}_{y} Δ y + l \cdot {e}_{z} Δ z ) \text{/} \overline{v} ( {x}_{i} , {y}_{j} , {z}_{k} )} , \qquad ( 9 )$$

where

$$p = \frac{1}{\overline{v} ( r )} ( {e}_{x} , {e}_{y} , {e}_{z} )$$

is the slowness vector with directional vector as (eₓ,e_{y},e_{z}); ν̅(r) is the average velocity in the local window centered at r; in the local window, the sampling intervals are Δx, Δy and Δz, and the number of sampling points are M, N, and L along the x, y, and z direction, respectively. Equation (9) is repeated for every image location and every plane wave direction. Assuming the number of plane waves is NP, the number of arithmetic operations per image point is O(NP×M×N×L).

In the method of current disclosure, the redundancy in calculation is reduced by performing windowed summations in planes along the x, y, and z directions instead of at every image locations.

For example, the windowed summation is first performed along the z direction according to equation (10).

$${u}_{z} ( {e}_{z} , {x}_{i} , {y}_{j} , {z}_{k} , ω ) = \frac{1}{L} {\sum }_{L = - L \text{/} 2}^{L \text{/} 2} u ( {x}_{i} , {y}_{j} , {z}_{k + l} , ω ) {e}^{- i ω l \cdot {e}_{z} Δ z \text{/} {v}_{z} ( {x}_{i} , {y}_{j} , {z}_{k} )} , \\ where {v}_{z} ( {x}_{i} , {y}_{j} , {z}_{k} ) = \frac{1}{L} {\sum }_{l = - L \text{/} 2}^{L \text{/} 2} v ( {x}_{i} , {y}_{j} , {z}_{k + l} ) . \qquad ( 10 )$$

Notice that the average velocity used here is the average velocity within the local 1D window along the z direction. The whole model is scanned over using equation (10). In this way, u_{z}(e_{z}, xᵢ, yⱼ, zₖ, ω) contributes to the plane wave decomposition of multiple image locations residing in the column in the z-direction and thus greatly reduces the computational complexity.

After that, the whole model is scanned over again by performing a similar summation along x direction,

$${u}_{x} ( {e}_{x} , {e}_{z} , {x}_{i} , {y}_{j} , {z}_{k} , ω ) = \frac{1}{M} {\sum }_{m = - M \text{/} 2}^{M \text{/} 2} {u}_{z} ( {e}_{z} , {x}_{i + m} , {y}_{j} , {z}_{k} , ω ) {e}^{- i ω m \cdot {e}_{x} Δ x \text{/} {v}_{x} ( {x}_{i} , {y}_{j} , {z}_{k} )} , \qquad ( 11 )$$

where

$${v}_{x} ( {x}_{i} , {y}_{j} , {z}_{k} ) = \frac{1}{M} {\sum }_{m = - M \text{/} 2}^{M \text{/} 2} {v}_{z} ( {x}_{i + m} , {y}_{j} , {z}_{k} ) ,$$

in which the average velocity used here is the average velocity within the local 2D window in x-z plane, followed by a summation along y direction

$${u}_{y} ( {e}_{x} , {e}_{y} , {e}_{z} , {x}_{i} , {y}_{j} , {z}_{k} , ω ) = \frac{1}{N} {\sum }_{n = - N \text{/} 2}^{N \text{/} 2} {u}_{x} ( {e}_{x} , {e}_{z} , {x}_{i} , {y}_{j + n} , {z}_{k} , ω ) {e}^{- i ω n \cdot {e}_{y} Δ y \text{/} {v}_{y} ( {x}_{i} , {y}_{j} , {z}_{k} )} , \qquad ( 12 )$$

where

$${v}_{y} ( {x}_{i} , {y}_{j} , {z}_{k} ) = \frac{1}{N} {\sum }_{n = - N \text{/} 2}^{N \text{/} 2} {v}_{x} ( {x}_{i} , {y}_{j + n} , {z}_{k} ) ,$$

in which the average velocity used here is the average velocity within the local 3D window.

As such, this embodiment of method scans the model three times—respectively along the z, x, y directions. As such, rather than stacking the plane waves in 3D as in the conventional method, the fast implementation method stacks the plane waves in three times, in z, x, and y directions, respectively. It thus decreases the computational cost to O((M+N+L)×NP) arithmetic operation per image point. Assuming M, N, and L are each 5, i.e., 5 sample points in each of z, x, and y directions. The computational cost of the method of this embodiment is about 12% of the corresponding conventional method. When each of M, N, and L equals 11, the computational cost of the method of this embodiment is about 2.5% of the corresponding conventional method.

The inventive method of the current disclosure uses three local average velocities for stacking, i.e., the local average velocities along z, x, y directions. It assumes that the velocity model has little lateral variation. In real earth, the lateral variation in the velocity is relatively small in most cases so that the inventive method maintains a high degree of accuracy while reducing computational cost. The accuracy of the inventive method can be validated by comparing the original wavefield with the reconstructed wavefield by summing up all the decomposed plane wave components obtained using the inventive method.

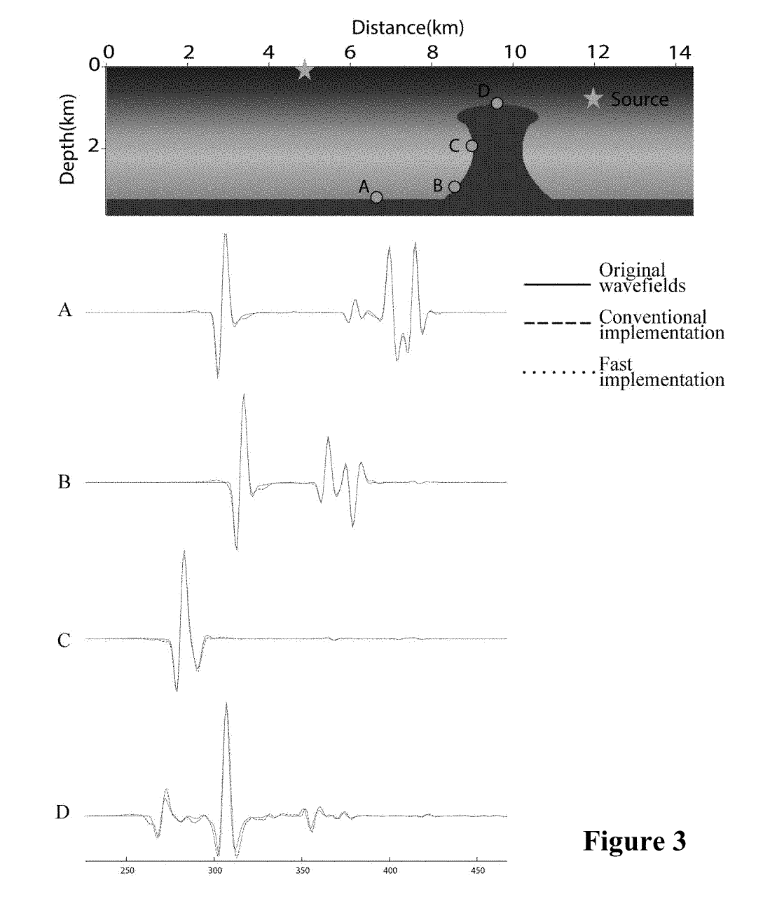

FIG. 3 validates the inventive method. It shows the wavefields at four selected locations (A, B, C, and D) in the salt dome model in the example shown in FIG. 1. The four locations are all located on the salt boundary. The solid line represents the original wavefields. The dashed line represents the reconstructed wavefields using a conventional implementation. The dotted line is the reconstructed wavefields using the method of current disclosure. Comparing the solid line (original wavefield) and dashed line (reconstructed based on a conventional method), the deviation of the reconstructed wavefield from the original wavefield is small. The error comes from the approximation to decompose the wavefield at the dispersion sphere. The difference between results from the conventional method (dash lines) and the method of current disclosure (dotted lines) is almost negligible. Even different average velocities are used, the new implementation can achieve almost the same accuracy as the conventional implementation.

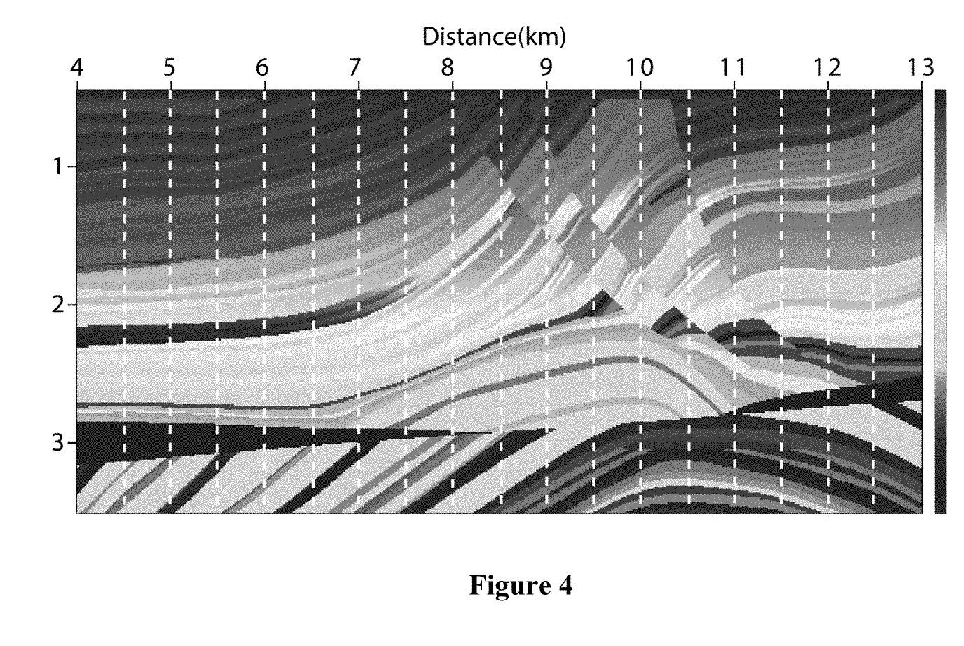

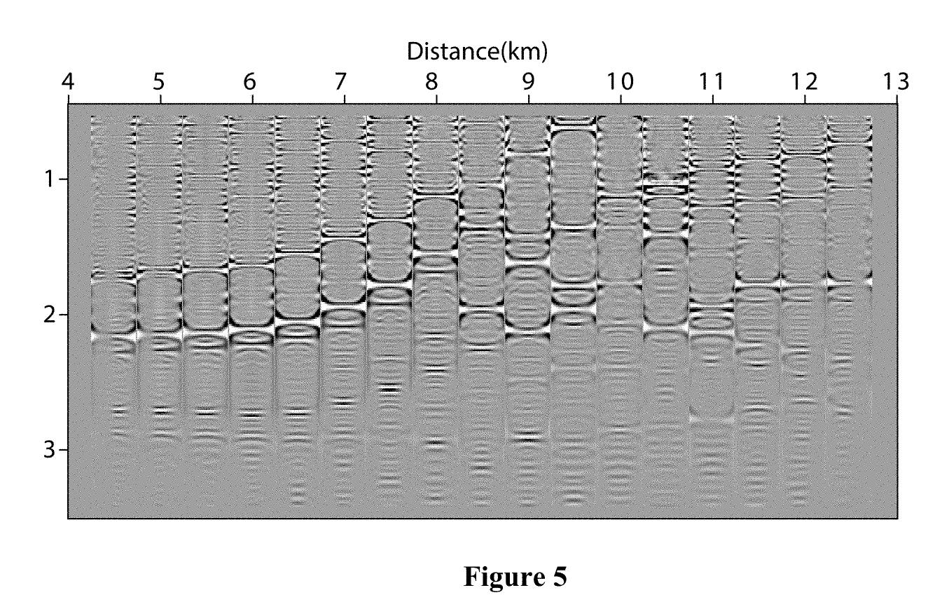

The new algorithm was tested on the Marmousi model. The velocity is illustrated in FIG. 4. Shown in FIG. 5 is ADCIG computed with the fast implementation algorithm. These angle gathers are calculated at 17 vertical lines starting from distance 4.5 km with an interval of 0.5 km. The angle range is −68°-68°. In such complicated model, the proposed method can produce ADCIG with very good quality.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A method for angle-domain common image gather (ADCIG) of a subsurface formation, comprising:
converting seismic waves at one of a plurality of image locations from time domain to frequency domain using Fourier transform;
decomposing seismic waves in the frequency domain into a plurality of local plane waves at the one of the plurality of image locations; and
producing a partial image by applying a cross-correlating imaging condition between the to the plurality of local plane waves at the one of the plurality of image locations.

2. The method of claim 1, wherein in the step of decomposing comprises stacking the plurality of local plane waves along z-direction according to equation (10) to obtain a first summation.

3. The method of claim 2, wherein in the step of decomposing comprises stacking the first summation long x-direction according to equation (11) to obtain a second summation.

4. The method of claim 3, wherein in the step of decomposing comprises stacking the second summation along y-direction according to equation (12) to obtain a third summation.

5. The method of claim 1, wherein the seismic wave comprises both incident waves from an energy source and scattered waves from a structure in the subsurface formation.

6. The method of claim 1, further comprising:
performing the converting step, the decomposing step, and the producing steps at each of the plurality of image locations to obtain a plurality of partial images; and
sorting the plurality of partial images into angle domain.
